(19) United States
(12) Patent Application Publication
(10) Pub. No.: US 2002/0035458 A1
(43) Pub. Date: Mar. 21, 2002

(54) Method and system for virtual surgery

(76) Inventors: Chang-Hun Kim, Seoul (KR); Young-Sik Jeong, Seoul (KR); Beom-Soo Oh, Seoul (KR); Hwa-Sung Kim, Seoul (KR)

Correspondence Address: Chung K. Ko, 1263 Lakeside Drive # 2190, Sunnyvale, CA, 94085, US

(21) Appl. No.: 09/839,862

(22) Filed: Apr. 21, 2001

Related U.S. Application Data
(60) Provisional application No. 60/235,161, filed on Sep. 20, 2000.

(51) Int. Cl. G06G 7/48

(52) U.S. Cl. 703/6

(57) ABSTRACT

A method and system is presented that can predict the result of a plastic surgery on a patient. The method includes the steps of taking pictures of a patient's hard and soft tissue, preparing a personalized 3-D model of the patient by overlaying the hard and soft tissue pictures and extracting outlines and feature points based on a standard 3-D model of a representative person, performing a virtual surgery by a doctor by manipulating the patient's hard tissue, and synthesizing the result of the virtual surgery by deriving changes in the patient's soft tissue according to the changes in the hard tissue.

### RELATED APPLICATION

This application claims the benefit of co-pending U.S. Provisional Application No. 60/235,161, filed on Sep. 20, 2000, entitled “Method and System for Virtual Surgery.”

### BACKGROUND OF THE INVENTION

1. Technical Field

This invention in general relates to image processing. More specifically, this invention relates to 3-D visualization of what a patient would look like after a plastic surgery.

2. Description of the Related Art

Plastic or cosmetic surgery has been developed to satisfy an age-long human desire to improve one's appearance. Despite the desire, many people in reality are hesitant to undergo such a surgical procedure partly because of the fear of having no assurance of what they would look like after the surgical procedure.

A traditional method of assuring the after-surgery result is to have a counseling session with a doctor (or a plastic surgeon) where the doctor gives an outline of a would-be appearance after surgery and possibly shows the pictures of other patients who had already underwent a similar surgery. This method, however, does not usually ease a patient's fear because the same result may not be duplicated for a different patient.

Another method is to do a “paper surgery” using a patent's x-ray picture. A tracing paper is overlaid on the x-ray picture to derive the outlines of the patient's soft and hard tissues in the physical part of interest. Then the doctor performs an imaginary surgery such as cutting bones, and shows the result by deriving changes in soft tissue as a result of changes in hard tissue. This method, however, suffers the disadvantage of requiring manual operation and tedious calculation. Further, the method does not produce any visually convincing presentation that can be used to persuade the patient.

Therefore, there is a need for a technique that can produce a simulated result of a proposed plastic surgery in an accurate and convincing manner.

### SUMMARY OF THE INVENTION

It is an object of the present invention to provide an accurate simulated result of a proposed plastic surgery on a patient in a cost effective manner.

Another object of the present invention is to provide a realistic visualization of the simulation result.

The foregoing and other objects are accomplished by providing a providing a result of a virtual surgery on a patient.

A particular embodiment of the invention includes the steps of receiving pictures of soft tissue and hard tissue of the patient; preparing preprocessing data necessary for virtual surgery to be performed by a doctor; performing a virtual surgery by manipulating the hard tissue, and simulating the result of the surgery by deriving changes in soft tissue in accordance to the manipulation of the hard tissue.

### BRIEF DESCRIPTION OF THE DRAWINGS

FIG. 1 is a process chart of virtual surgery of the present invention.

FIG. 2 is an illustration of extracting outlines and features points from X-ray and photo pictures.

FIGS. 3-6 are flow charts showing a detailed implementation of a digital plastic surgery system of the present invention.

FIG. 7 is an illustration of an embodiment of a service process enabling virtual surgery of the present invention.

FIG. 8 is an illustration of another embodiment of a service process enabling virtual surgery.

FIG. 9 is an illustration of yet another embodiment of a service process enabling virtual surgery.

FIG. 10 is an illustration of still another embodiment of a service process enabling virtual orthodontic surgery.

### DETAILED DESCRIPTION OF THE INVENTION

Virtual Surgery System

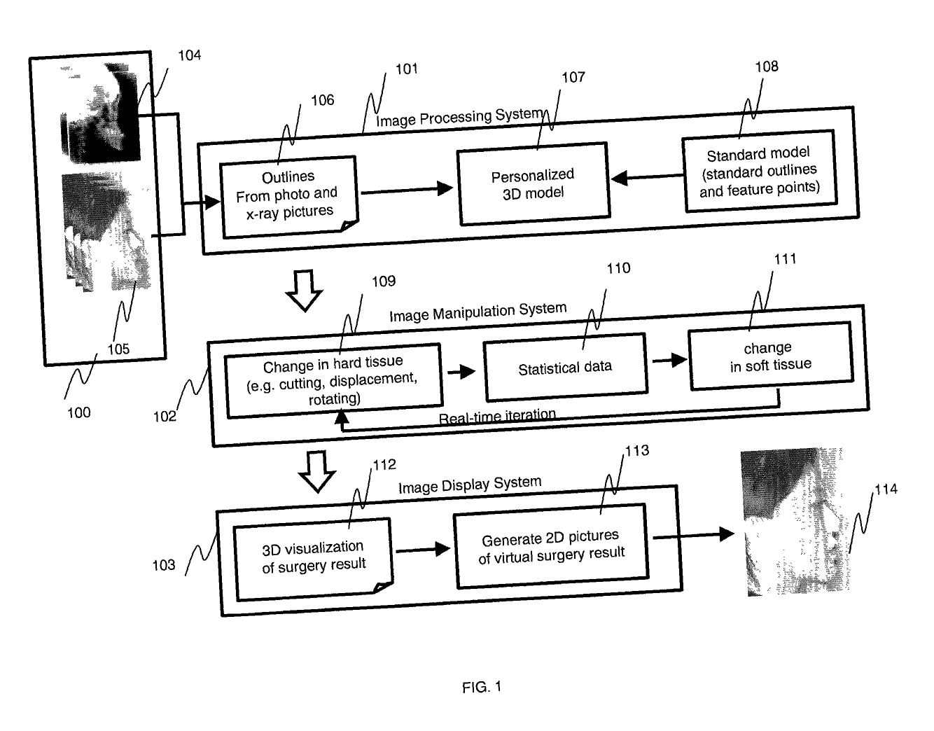

FIG. 1 illustrates a virtual surgery system of the present invention. The system includes an image acquisition system 100 for taking pictures of a patient's hard and soft tissue, an image processing system 101 for preparing preprocessing data necessary for performing a virtual surgery, an image manipulation system 102 for performing a virtual surgery, an image display system 103 for displaying the virtual surgery result.

1. Image Acquisition System

The image acquisition system includes an x-ray camera for taking an x-ray picture 104 of a patient's hard tissue as well as a camera for taking a photographic picture 105 of the patient.

2. Image Processing System

The image processing system 101 uses a computer to extract the outlines of a patient's face by overlaying the picture of hard tissue 104 and the picture of soft tissue 105.

A standard model 108 consists of the information on the soft tissue and hard issue of a representative person including features points representing soft and hard tissue movement, defined and used by the medical community in general. A further refined standard model may be developed and used that is specific to a particular race or a geographical region.

The extracted outlines 106 are matched to the standard model to generate a personalized model 107 specific for a particular patient by positioning the features points to the outlines.

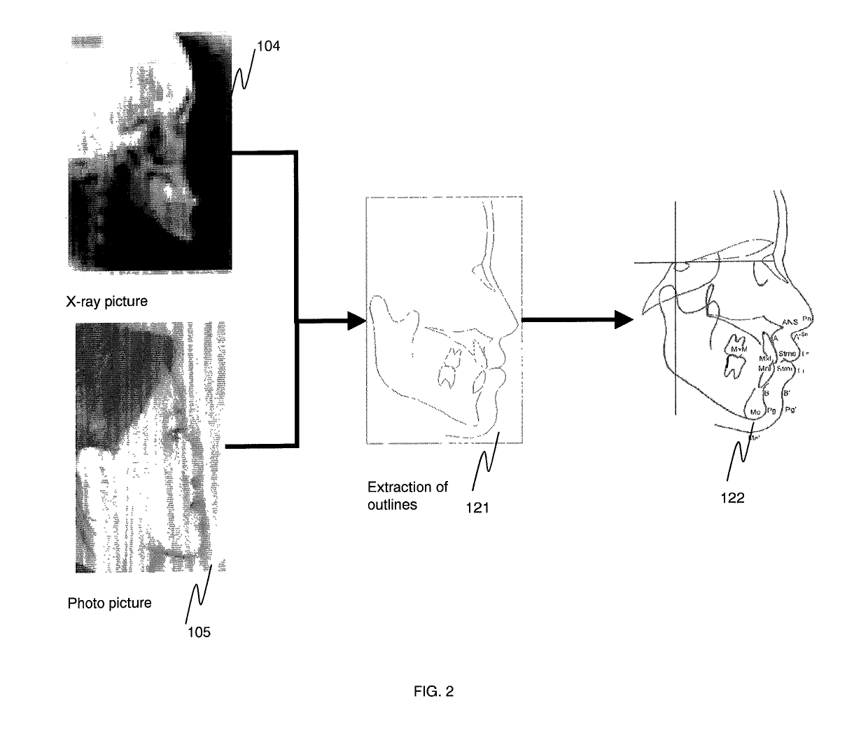

FIG. 2 further illustrates the process of extracting the feature points. A picture of hard tissue 104, such as an X-ray picture, and a picture of soft tissue 105, such as a facial photograph, are overlaid with each other (121) to extract the outlines of bones and facial features and the features points representing movement of hard and soft tissues (122).

3. Image Manipulation System

FIG. 1 also shows the image manipulation system 102 where a doctor such as a plastic surgeon performs a virtual surgery, which includes manipulation of hard tissues of the patient's body part, such as cutting, rotating and displacement of hard tissues (109). The virtual surgery simulates a physical surgery by using a simulation model 110 obtained through statistical data to calculate the change of the feature points in the soft tissue 111 as a result of change of the features points in hard tissue. The change in soft tissue 111 is calculated in real time to help the doctor try various choices of manipulation.

4. Image Display System

FIG. 1 also shows the image display system 103 for displaying the result of the virtual surgery performed. The pictures of the patient before surgery is used to construct a 3-D model of the patient. The image display system 103 displays 3-D visualization of the result 112. 2-D pictures from various angles 113 may be generated by projection from the 3-D visualization to help the plastic surgeon and the patient in a subsequent consulting session.

The virtual surgery system of the present invention is capable of various functions relating to virtual surgery and patient management. It offers the function of performing virtual surgery using a patent's pictures to predict the result of actual plastic surgery. It also offers the function of patient management such as calculating the doctor fees and the cost of surgery. It also offers the function of input/output such as printing digitized pictures of the area of virtual surgery, virtual surgery data, and virtual surgery results.

The virtual surgery system of the present invention may be offered in different ways. The system may be offered in a network environment where the server running the system is in a local area network or in the Internet so that a plastic surgeon may connect to the virtual surgery system to perform a virtual surgery. Or the system may be offered as a downloadable form so that a doctor may download the system through the Internet and operate as a standard alone system at the doctor's office.

Software Implementation of Digital Plastic Surgery System

An example of a virtual surgery system of the present invention is a digital plastic surgery system to predict the result of a plastic surgery on the face of a patient.

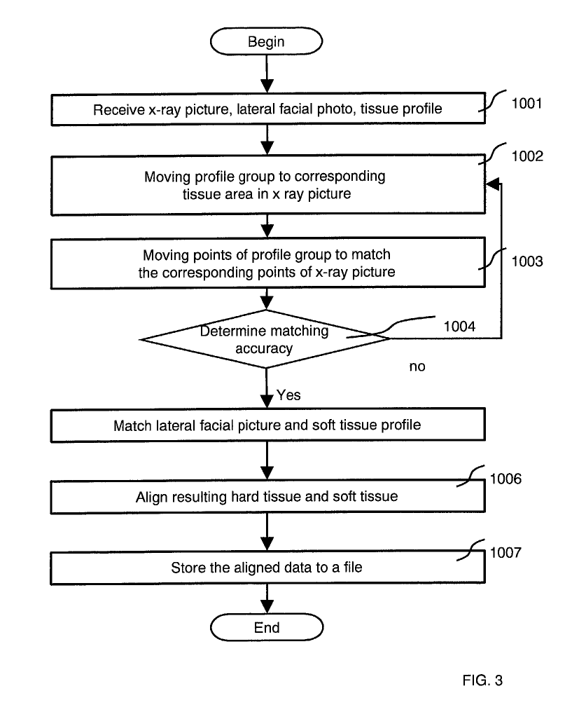

FIGS. 3-6 are flowcharts showing a detailed implementation of the digital plastic surgery system of the present invention using software running on Microsoft® Windows® family of operating system.

FIG. 3 shows the steps for preprocessing for digital plastic surgery. At step 1001, the program receives an x-ray picture and a lateral facial photo picture of a patient, and a profile containing the outline information of the hard and soft tissues, which is composed of anatomical feature points. For example, the outlines may consist of 9 groups of hard tissues and 2 groups of soft tissues, which are used on the maxillofacial paper surgery. At 1002, the program user matches the x-ray picture with all groups of hard tissues outlines by moving each group to the corresponding tissue area in the x-ray picture approximately. At 1003, the program user matches the x-ray picture by moving each point in the group in detail. At 1004, the program user determines whether matching of the outline group is accurate. At 1005, a similar technique is used to match the lateral facial picture and the soft tissue profile. At step 1006, the resulting hard tissue data and the soft tissue data are aligned. At step 1007, the program stores the aligned data as a file.

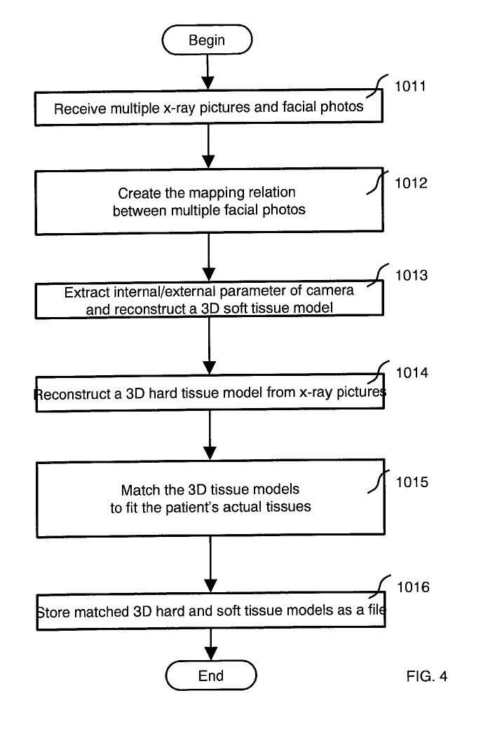

FIG. 4 shows preparation of pre-processing data needed for 3-D visualization after virtual surgery, namely, a 3-D hard tissue model and a 3-D soft tissue model. At 1011, the program receives multiple x-ray pictures and facial photo pictures of the patient. At step 1012, the program user designates a point at each picture corresponding to the same facial point of the patient. The program reconstructs a 3-D soft tissue point by extracting the internal/external parameters of the camera setting from each set of these points. Each 3-D soft tissue point will have not only the 3-D coordinates, but also a color value. The set of these 3-D soft tissue points are reconstructed into a 3-D soft tissue model having a texture. At 1014, the same technique is used to reconstruct a 3-D hard tissue model from the x-ray pictures. At 1015, the reconstructed hard and soft tissues are matched each other to fit the patient's actual hard and soft tissues by moving, rotating, adjusting the 3-D soft tissue model with respect to 3-D hard tissue. At step 1016, the program stores containing the matched 3-D hard and soft tissue models as a file.

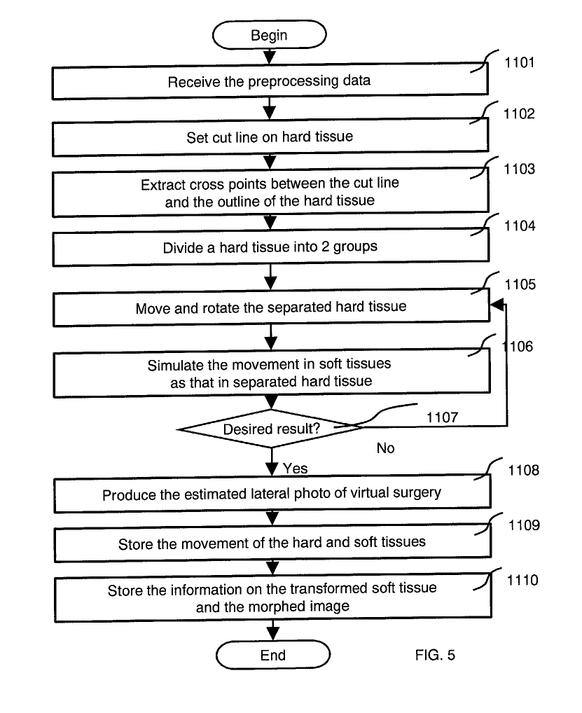

FIG. 5 shows the steps involved in performing a virtual surgery. At 1101, the program receives the preprocessing data stored as a file. At 1102, the program user draws a cut line using a mouse on the hard tissue part to be cut. At 1103, the program extracts cross points between the cut line and the outline of the hard tissue. At 1104, the maxillofacial group, for example, is divided into 2 groups based on the cut line so that the separated hard tissue groups can be moved or rotated at 1105. At 1106, the surgery simulation process calculates the changes in soft tissue outlines according to the movement of the separated hard tissue. Steps 1105 through 1107 are repeated in real time until the desired result is obtained at 1107. If the result is confirmed, at 1108, morphing is performed to produce the estimated photo of virtual surgery according to changes of the soft tissue group. The morphing is done by constructing a soft tissue mesh using a triangularization algorithm widely used in graphics, and transforming the mesh. At 1109, the program stores the movement of the hard tissue group and the information on the soft tissue transformation. At 1110, the program stores the information on the transformed soft tissue group and the morphed image.

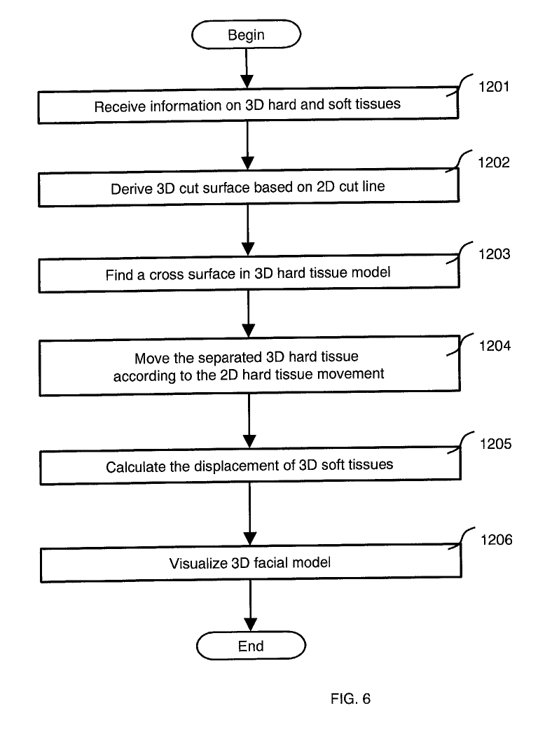

FIG. 6 shows the steps involved in 3-D visualization of the virtual surgery result. At 1201, the program receives the information on 3-D hard and 3-D soft tissue models. At 1202, a 3-D cut surface is derived based on the 2-D cut line. At 1203, the program finds a cross surface between the 3-D cut surface and the maxillofacial tissue group to use the cross surface to divide the hard tissue into 2 groups. At 1204, the separated 3-D hard tissue is moved according to the 2-D hard tissue movement in step 1106. At 1205, the program calculates the displacement of soft tissue according to the displacement of the hard tissue. The amount of 3-D soft tissue displacement depends on the skin elasticity on the face. The program assigns a weight to each area of the 3-D soft tissue based on empirical medical data. At step 1206, the program performs visualization of the 3-D facial model for the program user.

Service for Virtual Surgery

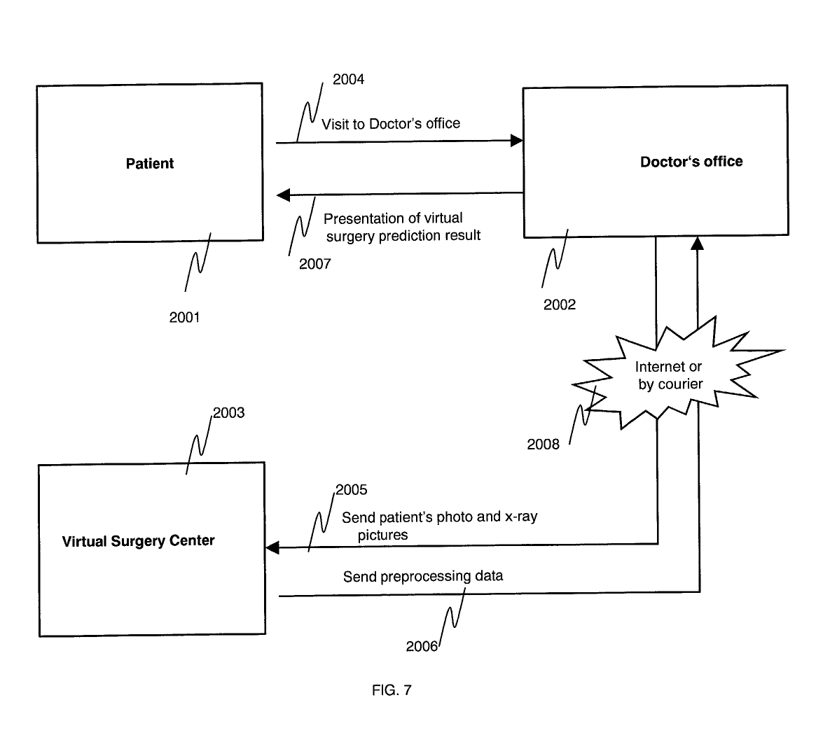

FIG. 7 illustrates an example of a service process where a doctor performs a virtual surgery simulating a plastic surgery on a patient who has requested counseling with the doctor. The service starts when a patient 2001 visits the doctor's office (2004). The office personnel take conventional and x-ray pictures of the body part of the patient. The pictures are sent to a virtual surgery center through the Internet 2008 or by courier (2005). The virtual surgery center 2003 prepares preprocessing data necessary for the doctor to perform a virtual surgery. The preprocessing data includes the outlines of the pictures and personalized model of the patient including features points representing movement of soft and hard tissues. The center sends the preprocessing data back to the doctor (2006). The doctor performs virtual surgery using the preprocessing data received (2002). The doctor sends the result of virtual surgery to the center. The center then prepares 3-D visualization of the result and sends back the result to the doctor. The doctor then presents the result to the patient (2007).

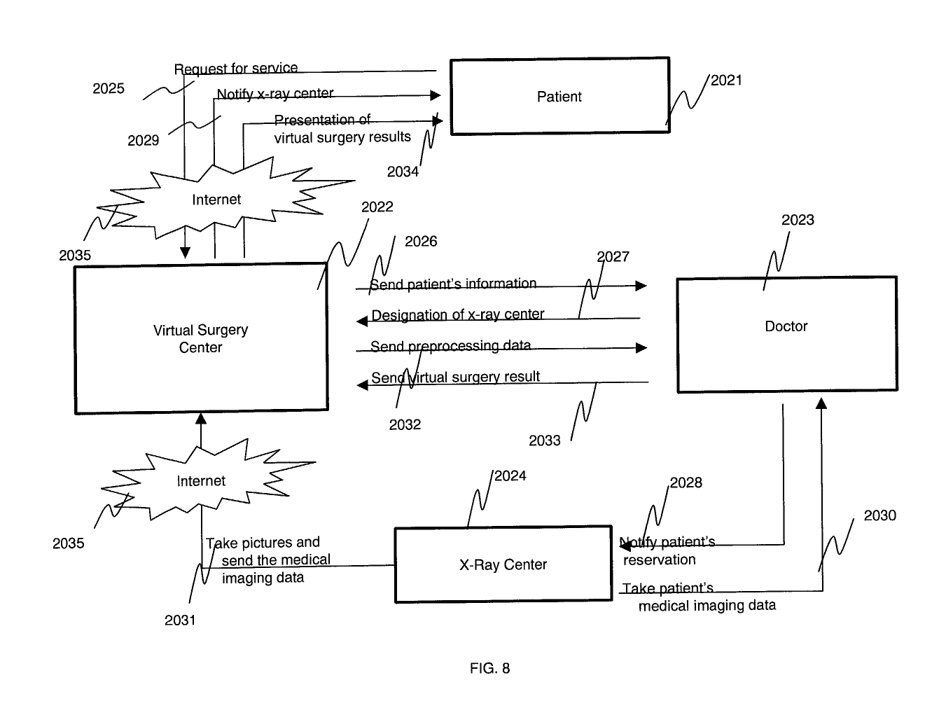

FIG. 8 illustrates another example of a service process enabling virtual surgery. A patient 2021 first contacts a virtual surgery center 2022 through the Internet 2035 or other means (2025). The virtual center 2022 contacts a doctor and sends the patient's information to the doctor (2026). The doctor designates an x-ray center 2024 and notifies the center of the patient's reservation (2028). When the patient takes x-ray pictures at the x-ray center 2024, which sends the data to the virtual surgery center 2022 (2031). The center then prepares preprocessing data and sends the data to the doctor (2032) who performs a virtual surgery and sends the result back to the center (2033). The center then contacts the patient to present the result (2034).

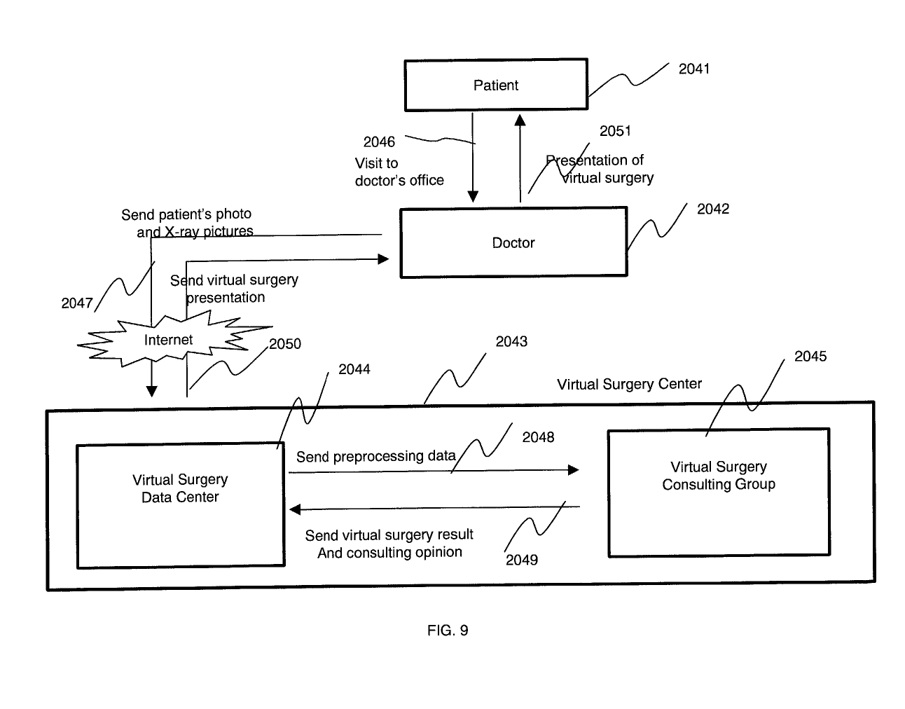

FIG. 9 shows yet another example of a service process enabling virtual surgery. Here a patient first visits (2026) a doctor who takes patient's x-ray and photo pictures and sends the pictures (2027) to a virtual surgery center 2123. The virtual surgery center has a data center 2024 that prepares preprocessing data and sends the data to a virtual surgery consulting group 2025 who belongs to the virtual surgery center (2028). The group performs virtual surgery and prepares a consulting opinion and sends them back to the data center (2029). The data center generates presentation of the virtual surgery result and sends it to the doctor (2050) who contacts the patient to present the result (2051).

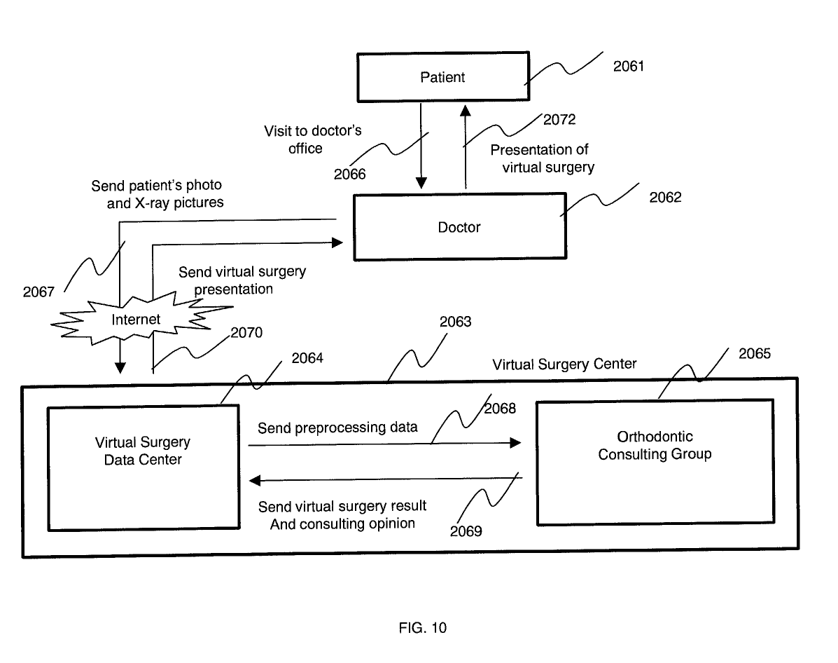

FIG. 10 shows still another embodiment of a service process enabling virtual orthodontic surgery. The service process is similar to the service process of FIG. 3 except that the virtual surgery consulting group is an orthodontic consulting group 2065.

While the invention has been described with reference to preferred embodiments, it is not intended to be limited to those embodiments. It will be appreciated by those of ordinary skilled in the art that many modifications can be made to the structure and form of the described embodiments without departing from the spirit and scope of this invention.

What is claimed is:

1. A method of performing a virtual surgery on a patient to predict the result of a plastic surgery that may be performed on a patient, comprising the steps of:
taking pictures of the patient's hard and soft tissue;
preparing preprocessing data necessary for a virtual surgery;
performing a virtual surgery by manipulating the patient's hard tissue making changes in the hard tissue; and
synthesizing the result of the virtual surgery by deriving changes in the patient's soft tissue according to the changes in the hard tissue.

2. The method of claim 1, wherein the step of taking data comprises the step of:
taking an x-ray picture of the patient's hard tissue.

3. The method of claim 1, wherein the step of taking data comprises the step of:
taking a photographic picture of the patient's hard tissue.

4. The method of claim 1, wherein the step of preparing preprocessing data comprises the step of:
generating a personalized 3-D model of the patient.

5. The method of claim 4, wherein the step of generating a personalized 3-D model comprises the steps of:
extracting an outline of the patient by overlaying the hard tissue picture and the soft tissue picture; and
extracting feature points of the patient by overlapping the outline onto a standard model containing outlines and standard feature points of a representative person.

6. The method of claim 1, wherein the step of manipulation includes cutting the hard tissue.

7. The method of claim 1, wherein the step of manipulation includes displacing the hard tissue.

8. The method of claim 1, wherein the step of manipulation includes rotating the hard tissue.

9. The method of claim 1, further comprising the step of visualizing the result of the virtual surgery in 3-D.

10. The method claim 9, further comprising the step of generating 2-D pictures of the 3-D visualization result.

11. A system for performing a virtual surgery on a patient to predict the result of a plastic surgery that may be performed on a patient, comprising:
an image acquisition system for taking pictures of the patient's hard and soft tissue;
an image processing system for preparing preprocessing data necessary for a virtual surgery;
an image manipulation system for performing a virtual surgery by manipulating the patient's hard tissue making changes in the hard tissue; and
an image display system for synthesizing the result of the virtual surgery by deriving changes in the patient's soft tissue according to the changes in hard tissue.

12. The system of claim 11, wherein said image acquisition system includes an x-ray camera for taking an x-ray picture of the patient's hard tissue.

13. The system of claim 11, wherein said image acquisition system includes a camera for taking a photographic picture of the patient's hard tissue.

14. The system of claim 11, wherein said image processing system includes means for generating a personalized 3-D model of the patient.

15. The system of claim 14, wherein said means for generating a personalized 3-D model includes:
means for extracting an outline of the patient by overlaying the hard tissue picture and the soft tissue picture; and
means for extracting feature points of the patient by overlapping the outline onto a standard model of outlines and feature points of a representative person.

16. The system of claim 11, wherein said image display system further includes means for presenting a 3-D visualization of the result of the virtual surgery.

17. The system of claim 16, wherein the image display system further includes means for generating 2-D pictures of the 3-D visualization.

18. A method of performing a virtual surgery on a patient to predict the result of a plastic surgery that may be performed by a doctor on a patient using the service of a virtual surgery center connected to the doctor through a network, comprising the steps of:
taking pictures of the patient's hard and soft tissue;
preparing, at the virtual surgery center, preprocessing data necessary for a virtual surgery;
performing a virtual surgery by manipulating the patient's hard tissue making changes in the hard tissue; and
synthesizing the result of the virtual surgery by deriving changes in the patient's soft tissue according to the changes in hard tissue.

19. The method of claim 18, wherein the network is the Internet.

20. The method of claim 18, wherein the virtual surgery center has a virtual surgery consulting group for providing consulting service related to virtual surgery.

21. The method of claim 20, wherein said virtual surgery consulting group includes a plastic surgeon.

22. The method of claim 20, wherein said virtual surgery consulting group includes an orthodontic dentist.
